(19) United States
(12) Patent Application Publication
(10) Pub. No.: US 2020/0137678 A1
(43) Pub. Date: Apr. 30, 2020

(54) SLICE MANAGEMENT DEVICE AND SLICE MANAGEMENT METHOD

(71) Applicant: NTT DOCOMO, INC., Tokyo (JP)

(72) Inventors: Yuki KATSUMATA, Tokyo (JP); Shigeru IWASHINA, Tokyo (JP); Akira YAMADA, Tokyo (JP); Takuya SHIMOJOU, Tokyo (JP)

(73) Assignee: NTT Docomo, Inc., Tokyo (JP)

(21) Appl. No.: 16/495,927

(22) PCT Filed: Feb. 15, 2018
(86) PCT No.: PCT/JP2018/005271

§ 371 Date: Sep. 20, 2019

(30) Foreign Application Priority Data
Mar. 21, 2017 (JP) 2017-054764

(51) Int. Cl. H04W 48/00; H04W 48/18; H04L 12/46; H04W 88/00

(52) U.S. Cl. CPC H04W 48/17; H04W 88/005; H04L 12/4641; H04W 48/18

(57) ABSTRACT

A network operating device is disclosed that serves as a slice management device and assigns a service to slices that are virtual networks generated on a network infrastructure. The slices are being arranged in a plurality of stages of a communication path along which communication is performed between a user equipment as a user terminal and a service server providing the service. The network operating device includes an information acquiring unit that acquires a slice setting request including a service requirement, a slice setting policy determining unit that determines a slice setting policy for setting slices, and a slice setting unit that performs a process relating to the settings of the slices in the plurality of stages on the basis of the setting policy.

### TECHNICAL FIELD

The present invention relates to a slice management device and a slice management method.

### BACKGROUND ART

In a network system using a conventional virtualization technology, hardware resources are virtually divided, and slices that are virtual networks logically generated on a network infrastructure are generated. Then, by assigning services to each slice, the services can be provided using networks of independent slices. Accordingly, in a case in which slices are assigned to services having various required conditions, required conditions of individual services can be easily satisfied, and signaling processes and the like thereof can be reduced.

### CITATION LIST

### Patent Literature

[Patent Literature 1] PCT Publication No. 2016/152588

### SUMMARY OF INVENTION

### Technical Problem

Conventionally, use of a virtualization technology in a core network is assumed. However, in recent years, disposing slices of a plurality of stages on a communication path when a user terminal uses a service by using the virtualization technology described above has been reviewed. However, in a case in which slices of a plurality of stages on a communication path are individually set, it is conceivable that, when seen from the entire communication path, slices appropriate for a service may not be set, and communication appropriate for the service may not be performed.

The present invention is in consideration of the description presented above, and an object thereof is to provide a slice management device and a slice management method capable of appropriately setting slices corresponding to an available service when the service is provided by a user terminal performing communication through slices of a plurality of stages.

### Solution to Problem

In order to achieve the object described above, a slice management device according to one embodiment of the present invention is a slice management device assigning a service using a virtual network to slices that are virtual networks generated on a network infrastructure, the slices being arranged in a plurality of stages of a communication path along which communication is performed between a user terminal using the service and a service server providing the service, the slice management device including: an information acquiring unit that acquires a slice setting request including a service requirement that is a requirement of a function or performance in a service provided using the virtual network; a slice setting policy determining unit that determines a setting policy for setting slices which satisfy the service requirement as the slices of the plurality of stages on the basis of results of comparison of costs calculated in accordance with settings of the slices of the plurality of stages; and a slice setting unit that performs a process relating to the settings of the slices in the plurality of stages on the basis of the setting policy determined by the slice setting policy determining unit.

In addition, a slice management method according to one embodiment of the present invention is a slice management method using a slice management device assigning a service using a virtual network to slices that are virtual networks generated on a network infrastructure, the slices being arranged in a plurality of stages of a communication path along which communication is performed between a user terminal using the service and a service server providing the service, the slice management method including: an information acquiring step of acquiring a slice setting request including a service requirement that is a requirement of a function or performance in a service provided using the virtual network; a slice setting policy determining step of determining a setting policy for setting slices which satisfy the service requirement as the slices of the plurality of stages on the basis of results of comparison of costs calculated in accordance with settings of the slices of the plurality of stages; and a slice setting step of performing a process relating to the settings of the slices of the plurality of stages on the basis of the setting policy determined in the slice setting policy determining step.

### Advantageous Effects of Invention

According to the present invention, a slice management device and a slice management method are provided which are capable of appropriately setting slices corresponding to an available service when the service is provided by a user terminal performing communication through slices of a plurality of stages.

### BRIEF DESCRIPTION OF DRAWINGS

FIG. 1 is a diagram illustrating the configuration of a communication system including a slice management device according to this embodiment.

FIG. 2 is a diagram illustrating functional blocks of an NW operating device corresponding to a slice management device.

FIG. 3 is a diagram illustrating an example of information relating to an RAN slice and a CN slice, which are currently operating, stored in a slice information storing unit of an NW operating device.

FIG. 4 is a diagram illustrating an example of information representing service requirements transmitted from a service operating device.

FIG. 5 is a diagram illustrating an example of an algorithm relating to cost calculation and determination of a slice setting policy used in a slice setting policy determining unit of an NW operating device.

FIG. 6 is a diagram illustrating another example of an algorithm relating to cost calculation and determination of a slice setting policy used in a slice setting policy determining unit of an NW operating device.

FIG. 7 is a sequence diagram illustrating a process performed in a communication system in a case in which a new service is introduced.

FIG. 8 is a diagram illustrating the configuration of a communication system including a slice management device according to this embodiment.

FIG. 9 is a sequence diagram illustrating a process in a communication system in a case in which a new service is introduced.

FIG. 10 is a diagram illustrating one example of the hardware configuration of an NW operating device and the like according to this embodiment.

### DESCRIPTION OF EMBODIMENTS

Hereinafter, an embodiment of the present invention will be described in detail with reference to the attached drawings. In description of the drawings, the same reference sign will be assigned to the same element, and duplicate description thereof will be omitted.

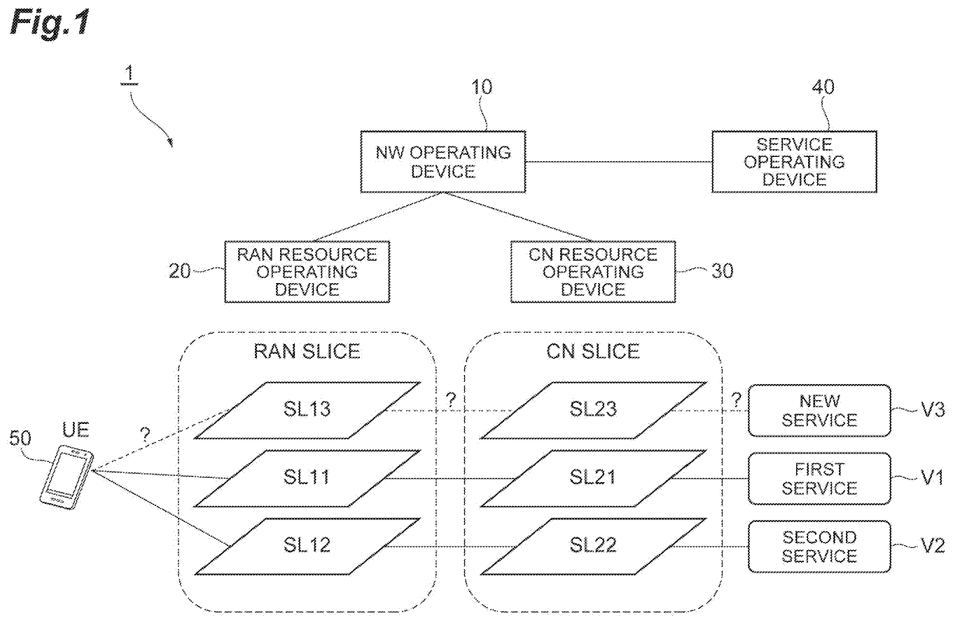

FIG. 1 illustrates the configuration of a communication system 1 including a slice management device according to this embodiment. The communication system 1 according to this embodiment is a system that provides a network service for a user equipment (UE) 50 that is a user terminal used by a user using data communication. A network service is a service using network resources such as a communication service (a dedicated line service or the like) or an application service (moving image distribution or a service using a sensor device such as an embedded device). In addition, the UE 50 is, for example, a so-called user terminal and includes many portable-type terminals such as a smartphone, a tablet terminal, and the like.

In the communication system 1, by assigning a service to a slice that is a virtualization network, a network service is provided for the user equipment (UE) 50. A slice is a virtual network or a service network that is logically generated on a network infrastructure by virtually dividing resources of links and nodes of a network device and combining the divided resources, and slices divide the resources and thus do not interfere with each other.

Creation and management of a slice for each service can be realized using a network slice control technology based on virtualization technologies such as a slice selection technology using a dedicated core network (DCN), network function virtualization (NFV)/software defined network (SDN), and the like.

A slice control architecture utilizing NFV and SDN includes a physical/virtual resource layer configuring a network of a physical server, a transport switch, and the like, a virtual network layer configuring a network slice having a functional set required for providing a service on physical/virtual resources, and a service instance layer that is an uppermost layer and manages service instances provided for end users. The physical/virtual resource layer, for example, is managed by a virtualized infrastructure manager (VIM) including an SDN controller (SDN-C). In addition, the virtual network layer, for example, is managed by a virtual network function manager (VNFM) and an NFV orchestrator (NFVO) for each network slice. The VIM, the VNFM, and the NFVO are defined as a management & orchestration (MANO) architecture. In addition, a required condition of a service instance in the service instance layer is monitored and assured by an operation support system/business support system (OSS/BSS).

As results of network slicing performed by the SDN-C and slicing of server resources performed by the VIM, assignment of the physical/virtual resource layer is performed. In addition, the VNGFM and the NFVO arrange functional sets on assigned resource slices. Then network slices created in this way are monitored by the OSS/BSS. As a result, slices corresponding to services are created and managed.

In the communication system 1, some of nodes realizing communication required for the UE 50 to use services are disposed on a slice that is a virtual network logically created on the network infrastructure. Accordingly, the UE 50 performs communication in a path through nodes and the like disposed on the slice.

In addition, in the communication system 1, when the UE 50 communicates with a server providing a service for using the service, there is a feature in which communication through slices of multiple stages selected in accordance with the service is performed. More specifically, in the communication system 1 illustrated in FIG. 1, the UE 50 performs communication by accessing a service server that is a server providing a service through a node set in an RAN slice disposed in a radio access network (RAN) and a node set in a CN slice disposed in a core network (CN). Accordingly, the UE 50 arranges a communication path with a service server that are two slices. In this way, the communication system 1 shows a situation in which so-called end-to-end (E2E) slicing is realized.

The RAN slice and the CN slice are set on the basis of requirements (for example, a delay, a frequency band, and the like) required for a service and the like. In the communication system 1, in a case in which the UE 50 uses a first service (for example, a service using mMTC/massive Machine Type Communications), the UE 50 accesses a slice SL11 among RAN slices, accesses a slice SL21 among CN slices, and then communicates with a service server V1 of the first service. In addition, in a case in which the UE 50 uses a second service (for example, a service using URLLC/Ultra-Reliable and Low Latency Communications), the UE 50 accesses a slice SL12 among RAN slices, accesses a slice SL22 among CN slices, and communicates with a service server V2 of the second service. In this way, in a case in which the UE 50 uses a specific service, the UE 50 performs communication by accessing an RAN slice and a CN slice deter fined in accordance with the service in advance.

In a case in which a new service is newly introduced into the system as described above, it is required to determine an RAN slice and a CN slice to be accessed by the UE 50 using the new service in advance. An RAN slice and a CN slice corresponding to the new service are determined on the basis of a service requirement of the new service. The service requirement represents a requirement of a function or performance in a service.

Here, as an RAN slice and a CN slice corresponding to a new service, it may be considered to newly create a slice SL13 that is an RAN slice and a slice SL23 that is a CN slice. On the other hand, in a case in which an existing slice corresponds to a service requirement of a new service, a technique of overlapping the new service with the existing slice may be considered. In addition, it may be considered to newly generate only one of the slice SL13 that is an RAN slice and the slice SL23 that is a CN slice and overlap the other with an existing slice. However, conventionally, a method of setting an RAN slice and a CN slice when a new service is introduced has not been reviewed. In contrast to this, the communication system 1 according to this embodiment solves the problem described above and enables slices of multiple stages to be accessed when communication is performed when the UE 50 communicates with a service server V3 of a new service to be appropriately set.

Each device included in the communication system 1 will be described. As illustrated in FIG. 1, the communication system 1 is configured to include a network (NW) operating device 10, a radio access network (RAN) resource operating device 20, and a core network (CN) resource operating device 30.

The NW operating device 10 has a function of a slice management device having a function of setting a slice corresponding to a service on the basis of a slice setting request from the service operating device 40. The service operating device 40 is a device managed by a company providing a service or the like and has a function of notifying the NW operating device 10 of a service requirement. The NW operating device 10 individually sets slices corresponding to the service for both the RAN slice and the CN slice based on this service requirement. In addition, the determination of slices is also on the basis of information of resources provided from the RAN resource operating device 20 and the CN resource operating device 30. Details of the NW operating device 10 and a method of determining slices that is performed by the NW operating device 10 will be described later. The function of the NW operating device 10, for example, can be mounted in an NFVO defined as a MANO architecture. In addition, the function described above may be configured to be mounted in a device having a slice management function or a slice selection function that is newly defined.

The RAN resource operating device 20 has a function of managing physical resources of RAN slices. Physical resources used for building RAN slices are managed by the RAN resource operating device 20. The RAN resource operating device 20 notifies the NW operating device 10 of information relating to physical resources that can be used for RAN slices, use statuses thereof, and the like. In addition, the RAN resource operating device 20 has a function of performing changes (creation, deletion, expansion, reduction, and the like) relating to slices within physical resources managed by its own device on the basis of a direction from the NW operating device 10. The RAN resource operating device 20 performs changes of slices on the basis of a direction from the NW operating device 10, whereby an RAN slice corresponding to a service is arranged. The function of the RAN resource operating device 20, for example, may be configured to be mounted in a device having a physical resource management function that is newly defined. In addition, the VIM may be configured to simultaneously manage virtual resources and physical resources relating to RAN slices.

The CN resource operating device 30 has a function of managing physical resources of CN slices. Physical resources used for building CN slices are managed by the CN resource operating device 30. The CN resource operating device 30 notifies the NW operating device 10 of information of physical resources that can be used for CN slices, use statuses thereof, and the like. In addition, the CN resource operating device 30 has a function of performing changes (creation, deletion, expansion of resources, reduction of resources, and the like) relating to slices within physical resources managed by its own device on the basis of a direction from the NW operating device 10. The CN resource operating device 30 performs changes of slices on the basis of a direction from the NW operating device 10, whereby a CN slice corresponding to the service is arranged. The function of the CN resource operating device 30, for example, may be mounted in a VNFM, a VIM, or the like defined as a MANO architecture or may be mounted in any other device.

In addition, the functions relating to the NW operating device 10, the RAN resource operating device 20, and the CN resource operating device 30 may be housed in the same device. Furthermore, each of the functions relating to the NW operating device 10, the RAN resource operating device 20, and the CN resource operating device 30 may be realized by a plurality of devices.

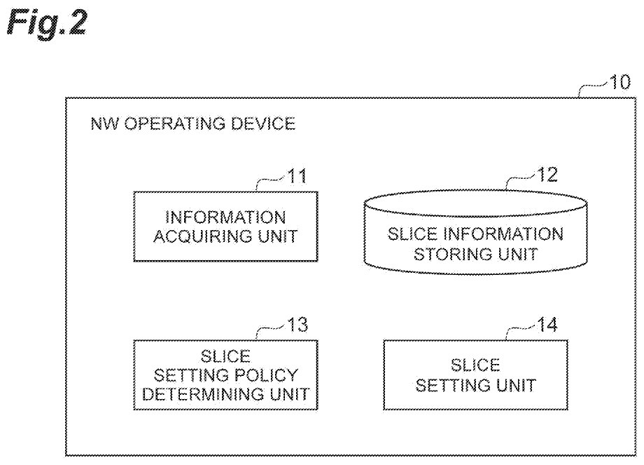

Next, the NW operating device 10 will be described with reference to FIG. 2. The NW operating device 10 is configured to include an information acquiring unit 11, a slice information storing unit 12, a slice setting policy determining unit 13, and a slice setting unit 14.

The information acquiring unit 11 has a function of acquiring information (capacities, use statuses, and the like of physical resources) relating to RAN slices and information (capacities, use statuses, and the like of physical resources) relating to CN slices by communicating with the RAN resource operating device 20 and the CN resource operating device 30. The information received from the RAN resource operating device 20 and the information acquired from the CN resource operating device 30 are stored in the slice information storing unit 12. In addition, the information acquiring unit 11 has a function of receiving a slice setting request designating a service requirement from the service operating device 40. Information included in the slice setting request is transmitted to the slice setting policy determining unit 13.

The slice information storing unit 12 has a function of storing information relating to RAN slices and CN slices. In the information relating to RAN slices and CN slices, information relating to an RAN slice and a CN slice that are currently operated is included. In addition, in the information relating to RAN slices and CN slices, information relating to physical resources available as slices managed by the RAN resource operating device 20 and the CN resource operating device 30 is included.

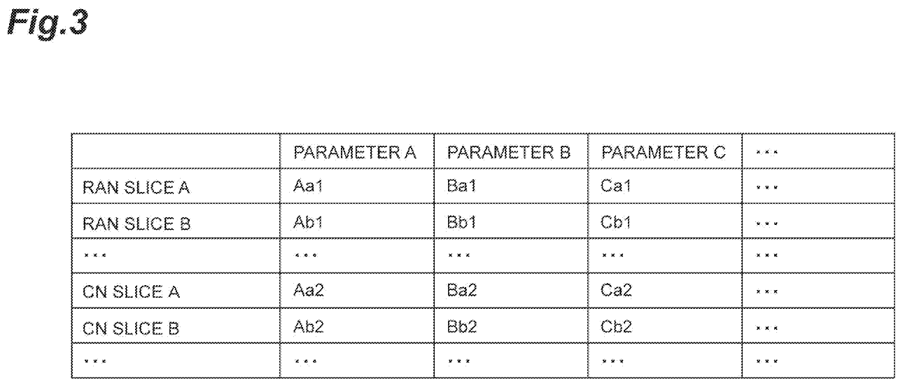

An example of information relating to currently operated RAN slices and CN slices stored in the slice initiation storing unit 12 is illustrated in FIG. 3. As illustrated in FIG. 3, in the slice information storing unit 12, information relating to a setting of a slice is stored for each of a plurality of RAN slices operated by the RAN resource operating device 20 and a plurality of CN slices operated by the CN resource operating device 30. In the example illustrated in FIG. 3, information relating to a plurality of parameters (parameters A to C) is stored for each slice. In this way, the slice information storing unit 12 stores intonation relating to features of a slice for each slice.

In addition, examples of the information relating to features of a slice include a throughput (a user experienced data rate), a delay (E2E latency), mobility, a density of connections (a connection density), a density of communication speed (a traffic density), and the like. Such intonation is information that is described in NGMN Whitepaper. In addition, in a case in which slices of a plurality of stages are arranged between the UE 50 and a service server as in this embodiment, as preferable information to be taken into account when an appropriate slice is set, for example, there are the number of users to be housed, available frequency bands, available access modes, UE location information (information relating to an area of a UE in which the slice is accessible), radio use efficiency, and the like, but the information is not limited thereto. The slice information storing unit 12 collects and stores information that is necessary for management of slices from the RAN resource operating device 20 and the CN resource operating device 30.

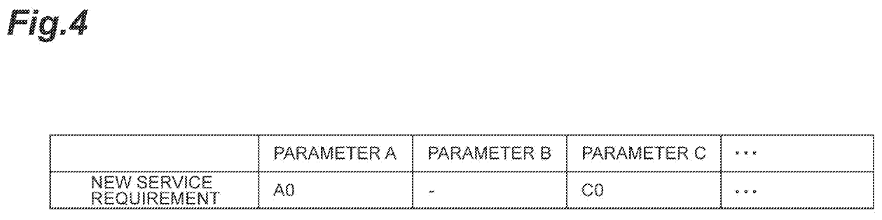

The information relating to the service requirement transmitted from the service operating device 40 corresponds to the information stored by the slice information storing unit 12 of the NW operating device 10. An example of the information representing a service requirement transmitted from the service operating device 40 is illustrated in FIG. 4. Parameters A to C illustrated in FIG. 4 correspond to parameters A to C of the information (FIG. 3) stored in the slice information storing unit 12. In the example illustrated in FIG. 4, requirements are defined for the parameter A and the parameter C as new service requirements. On the other hand, a requirement is not defined for the parameter B. In this way, service requirements of a new service designate a part of information (parameters) representing features of slices used in the information stored in the slice information storing unit 12.

Referring back to FIG. 2, the slice setting policy determining unit 13 has a function of calculating a cost conceived when a slice corresponding to a service is set on the basis of service requirements transmitted from the service operating device 40. In addition, the slice setting policy determining unit 13 has a function of determining a slice setting policy relating to a setting of a slice for which a service requirement is satisfied, and the cost is appropriately reduced on the basis of results of calculation of costs and the like.

As described above, in a case in which a new service is introduced, some policies for setting a slice corresponding to the service are considered. More specifically, as policies for setting a slice corresponding to a service, a policy of newly generating a slice, a policy of overlapping with an existing slice, a policy of extending existing slices and overlapping the slices with each other, and the like may be considered. For a slice corresponding to a service, it is assumed that the service requirement is satisfied, and thus it is natural to set a slice satisfying the service requirement. However, there are many cases in which one policy for setting a slice cannot be determined in accordance with only the condition.

Thus, the slice setting policy determining unit 13 calculates a cost in a case in which a slice corresponding to a new service is set for each stage (an RAN and a CN) under each condition. A “cost” according to this embodiment represents an overall load occurring when a slice of a new service is set and operates. For example, the cost includes energy consumption accompanying the operation and the like in addition to a capital expenditure (CAPEX) and an operating expenditure (OPEX). In a case in which slices of a plurality of stages are arranged, the slice setting policy determining unit 13 according to this embodiment evaluates a total load when slices of a plurality of stages disposed in a communication path operate as a cost instead of evaluating a load in a slice of one stage layer (for example, only an RAN slice) as a cost. By employing such a configuration, a situation in which a total cost increases can be prevented as a result of performing setting focusing on the cost of slices of one stage layer,.

The NW operating device 10 selects loads used for calculation performed by the slice setting policy determining unit 13 from among loads assumed to be such “costs” thereof and calculates the loads. All the patterns in a case in which slices of a plurality of stages are set such that they satisfy the service requirement are targets of cost calculation. A combination of slices of which the cost is sufficiently low (the load is sufficiently low) that satisfy the service requirement after comparison of results of calculation of costs for all the patterns is a combination of slices that becomes a policy for setting slices determined by the slice setting policy determining unit 13. A method of calculating the cost used by the slice setting policy determining unit 13 is not particularly limited, and various techniques may be used.

In addition, the slice setting policy determining unit 13 may be configured to determine a combination of slices of which the cost becomes a minimum and which satisfies the service requirement as a combination of slices that becomes a policy for setting slices. In such a case, the cost used for operating slices can be most reduced. However, in a case in which a combination of slices of which the cost becomes a minimum is used, a case in which it is difficult to perform an operation from viewpoints other than the cost may be considered although there is superiority from the viewpoint of the cost. In such a case, a combination of slices other than the combination of which the cost becomes a minimum may be configured to be selected.

In addition, a case in which the amount of calculation of costs relating to the setting of slices becomes massive may be considered. For example, as in the communication system 1 according to this embodiment, in a case in which slices are arranged in two stages of the RAN slice and the CN slice, a slice is individually set for each of the RAN slice and the CN slice, and accordingly, it is necessary to individually calculate the cost in a case in which each of the RAN slice and the CN slice is set to a specific condition also when the cost is calculated. Accordingly, when the number (stages) of slices arranged in a communication path increases, the number times of calculation of costs increases by that much.

In addition, there is a possibility that the cost changes due to features of a slice that is newly set. In other words, there are cases in which the cost changes in accordance various parameters included in the features of the slice causing new creation/overlapping of a slice having a certain setting.

In addition, even in a case in which an existing slice cannot satisfy a service requirement of a new service, there are cases in which the service requirement can be satisfied by extending resources of an existing slice. In such cases, it is necessary to individually calculate a cost also in a case in which resources of an existing slice is extended. In this way, there is a possibility that the amount of cost calculation will become massive due to the number of combined patterns of slices in each stage, the number of parameters used for calculation, and the like.

Accordingly, when the cost is calculated, it is assumed that calculation with parameters representing features of the slice taken into account is also necessary. Accordingly, the slice setting policy determining unit 13 may appropriately change the algorithm of the calculation and the like for the purpose of completing calculation of costs using a simpler calculation method and the like with the amount of calculation required for the cost calculation taken into account.

In addition, in a case in which characteristics of a communication path from a UE to a service server acquired as a result of a combination of slices of multiple stages (in this embodiment, an RAN slice and a CN slice) set as slices of a new service deviate from the service requirement of the new service transmitted from the service operating device 40, the combination cannot be employed. Accordingly, as in this embodiment, in a case in which slices of multiple stages are arranged in a communication path between a UE and a service server, it is necessary to verify whether a combination of slices set in each stage satisfies a service requirement. The slice setting policy determining unit 13 also verifies whether the service requirement is satisfied and performs a process of excluding a combination of slices not satisfying the service requirement from candidates for the combination of slices used in correspondence with a new service.

Thus, as one method of verifying whether a combination of slices selected in each stage can satisfy the service requirement more simply, there is a method of simply performing an evaluation by classifying information (parameters) representing features of slices into three types in accordance with the characteristics of the features in advance.

More specifically, parameters relating to features of slices are classified into a comparison type, a sum type, and a single type. The comparison type is a parameter for determining whether or not a parameter having a smallest value among parameters of a slice satisfies the service requirement in a communication path between the UE and the service server using a method of selecting a parameter having a smallest value among parameters of a slice set in each stage between the UE and the service server and determining whether or not the value satisfies the service requirement. An example of such a parameter is a throughput. Next, the sum type is a parameter for determining whether a parameter of the slice in each stage satisfies a service requirement in a communication path between the UE and the service server using a method of comparing a value acquired by summing parameters of the slice set in each stage between the UE and the service server with the service requirement. An example of such a parameter is a delay. Next, the single type is a parameter for determining whether a parameter of each slice set in each stage between the UE and the service server satisfies a service requirement in a communication path between the UE and the service server using a method of individually comparing the parameter of each slice set in each stage between the UE and the service server with the service requirement. An example of such a parameter is a radio use efficiency.

As described above, parameters are classified into three types in accordance with the characteristics thereof in advance, and it is verified whether a combination of slices selected in the stages can satisfy the service requirement on the basis of a calculation rule based on the characteristics of the parameters. In a case in which such a configuration is employed, for example, when a delay that is a parameter of the sum type is evaluated, it can be avoided to perform in unnecessary calculation such as a comparison of an individual parameter with the service requirement or the like. Accordingly, the efficiency of the verification rises, and the amount of calculation can be decreased.

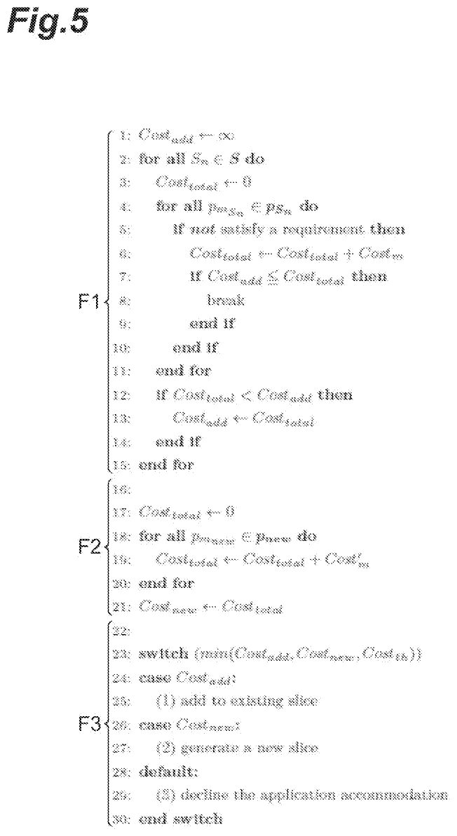

An example of an algorithm relating to cost calculation and determination of a slice setting policy used by the slice setting policy determining unit 13 is illustrated in FIG. 5. In a part of an algorithm Fl in the example illustrated in FIG. 5, in cost calculation, cost calculation in a case in which a slice corresponding to a new service overlaps with an existing slice is performed. In addition, in a part of an algorithm F2, in the cost calculation, cost calculation in a case in which slices corresponding to a new service are newly arranged is performed. Further core, in a part of an algorithm F3, a slice setting policy is determined.

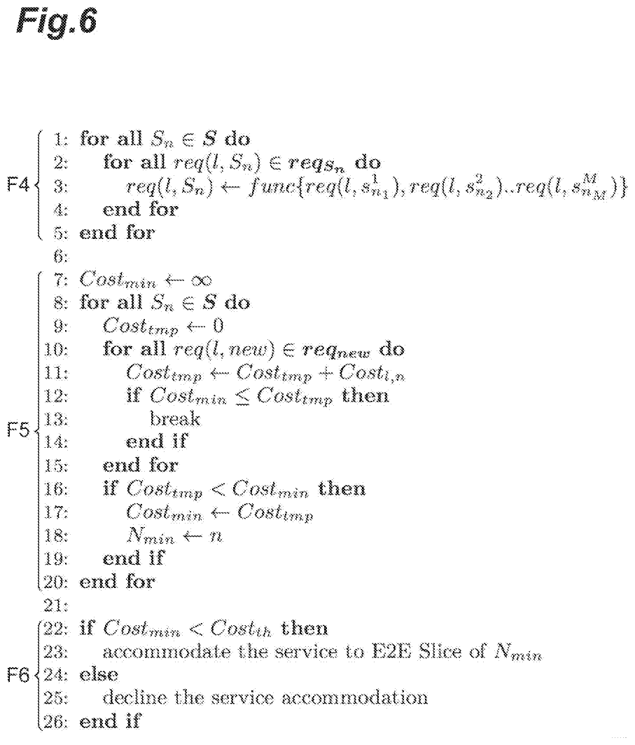

Another example of an algorithm relating to cost calculation and determination of a slice setting policy used by the slice setting policy determining unit 13 is illustrated in FIG. 6. In the example illustrated in FIG. 6, first, in a part of an algorithm F4, in cost calculation, calculation of a service requirement that is satisfied for each combination of slices of stages is performed. In addition, in a part of an algorithm F5, cost calculation when a service is housed in slices is performed. At this time, calculation is performed for both cases including a case in which a new service overlaps with existing slices in each stage and a case in which slices corresponding to a new service are newly arranged. The cost is calculated for each of all the combinations of slices in the stages, and a combination of which the calculation cost is a minimum is identified. In addition, in the algorithm F3, a slice setting policy is determined on the basis of the cost calculation described above.

Although two algorithms are illustrated in this embodiment, the algorithms relating to the cost calculation and the determination of a slice setting policy may be appropriately changed. The slice setting policy determining unit 13 evaluates whether a combination of slices selected in the stages satisfies the service requirement and calculates a cost of the combination and determines a combination of slices of which the cost is the lowest as a slice setting policy.

Referring back to FIG. 2, the slice setting unit 14 has a function of performing processes relating to the setting of slices such as a process of notifying the RAN resource operating device 20 and the CN resource operating device 30 of the slice setting policy determined by the slice setting policy determining unit 13 and the like. The slice setting policy transmitted from the slice setting unit 14 to the RAN resource operating device 20 and the CN resource operating device 30 may also be a slice design drawing. The slice design drawing may be generated by the slice setting policy determining unit 13 or may be generated by the slice setting unit 14. In addition, the processes relating to setting of slices performed by the NW operating device 10 include a process of transmitting the slice design drawing to the RAN resource operating device 20 and the CN resource operating device 30 and directing setting of slices as in this embodiment. The RAN resource operating device 20 and the CN resource operating device 30 perform a process relating to new creation of slices or overlapping on the basis of the slice setting policy transmitted from the slice setting unit 14. In addition, after slices are set by the RAN resource operating device 20 and the CN resource operating device 30, the slice setting unit 14, after checking that the slices function by satisfying the service requirement, may have a function of notifying the service operating device 40 of completion of setting of the slices.

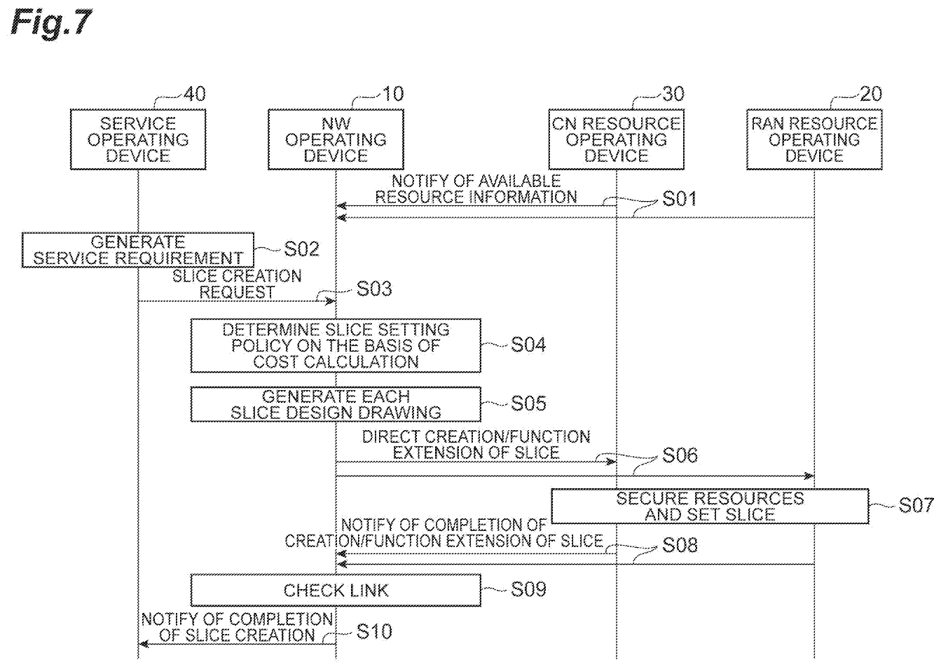

Next, the process performed by the communication system 1 in a case in which a new service is introduced will be described with reference to FIG. 7. In the process illustrated in FIG. 7, a slice management method according to this embodiment is included. First, the RAN resource operating device 20 and the CN resource operating device 30 notify the NW operating device 10 of available resource information (S01). This notification may be configured to be transmitted regularly as information or may be performed with being triggered upon introduction of a new service. Accordingly, the notification may be configured to be performed after reception of a service requirement from the service operating device 40 to be described later (S03). When information of available resources is acquired from the RAN resource operating device 20 and the CN resource operating device 30, the information acquiring unit 11 of the NW operating device 10 stores the acquired information of available resources in the slice information storing unit 12. In addition, although not illustrated in FIG. 7, the slice information storing unit 12 also stores information relating to RAN slices managed by the RAN resource operating device 20 and information relating to CN slices managed by the CN resource operating device 30.

Next, in a case in which a new service is introduced, the service operating device 40 generates a service requirement (S02). The service requirement is transmitted from the service operating device 40 to the NW operating device 10 as a slice setting request (S03: information acquiring step). The slice setting request including the service requirement is acquired by the information acquiring unit 11 of the NW operating device 10 and is transmitted to the slice setting policy determining unit 13.

The slice setting policy determining unit 13 of the NW operating device 10 performs cost calculation on the basis of the service requirement transmitted from the service operating device 40 and the information stored in the slice information storing unit 12 and determines a slice setting policy (S04: slice setting policy determining step). The process performed by the slice setting policy determining unit 13 for determining a slice setting policy is as described above. When the slice setting policy is determined, the slice setting policy determining unit 13 generates a slice design drawing for setting slices in the RAN resource operating device 20 and the CN resource operating device 30 for the RAN resource operating device 20 and CN resource operating device 30 (S05: slice setting step).

Thereafter, the slice design drawing is transmitted from the slice setting unit 14 of the NW operating device 10 to the RAN resource operating device 20 and the CN resource operating device 30, and the setting of slices represented in the slice design drawing is directed (S06: slice setting step). In the slice design drawing, details of a process relating to creation or overlapping of slices are included. Thus, the RAN resource operating device 20 and the CN resource operating device 30 perform securing of physical resources required for slices and setting of the slices on the basis of the slice setting policy and set the slices represented in the slice design drawing (S07). In addition, when the setting of the slices is completed, completion of the process is notified from each of the RAN resource operating device 20 and the CN resource operating device 30 to the NW operating device 10 (S08).

When notifications indicating completion of the processes relating to setting of the slices are received from the RAN resource operating device 20 and the CN resource operating device 30, the slice setting unit 14 of the NW operating device 10 checks that a communication path from the UE to the service server through the set slices is secured (linked), and the service requirement is satisfied (S09). In addition, in a case in which it is checked that the communication path from the UE to the service server does not satisfy the service requirement as a result of checking performed by the slice setting unit 14 of the NW operating device 10, the slice setting unit 14 repeats the process of inquiring of the RAN resource operating device 20 and the CN resource operating device 30 again, checking the policy determined by the slice setting policy determining unit 13, and the like such that a communication path satisfying the service requirement is generated.

In a case in which it is checked by the slice setting unit 14 that a communication path from the UE to the service server through the set slices is secured and the service requirement is satisfied, completion of the process relating to the setting of slices is notified from the slice setting unit 14 to the service operating device 40 (S10). As described above, the process relating to setting of slices corresponding to a new service is completed in the communication system 1.

As described above, according to the NW operating device 10 functioning as a slice management device included in the communication system 1 and the slice management method using the NW operating device 10 according to this embodiment, in the slice setting policy determining unit 13, while the service requirement is satisfied in a communication path between the UE and the service server on the basis of the service requirement acquired by the information acquiring unit 11, a slice setting policy of a plurality of stages is determined on the basis of results of comparison of costs calculated in accordance with setting of slices of a plurality of stage. Then, the slice setting unit 14 performs a process relating to setting of slices in a plurality of stages on the basis of the setting policy determined by the slice setting policy determining unit. In this way, the slice setting policy determining unit 13 of the NW operating device 10 determines a slice setting policy on the basis of results of comparison of costs calculated in accordance with setting of slices in a plurality of stages. Accordingly, slices satisfying the service requirement and selected on the basis of costs are set in a plurality of stages on the communication path, and accordingly, when an available service is provided as the user terminal performs communication through slices of a plurality of stages, the slices corresponding to the service can be appropriately set.

Conventionally, optimization at the time of assigning slices to each service has been reviewed. However, as in this embodiment, a method of assigning slices when a communication path arranged between the UE and the service server is through a plurality of slices, in other words, a service is provided for a user terminal by performing communication using a communication path along which slices of a plurality of stages are arranged has not been reviewed sufficiently. In contrast to this, according to the slice management device and the slice management method of this embodiment, when slices of a plurality of stages are set, costs are calculated, and the slices are set on the basis of results of the calculation. In other words, slices are set with a cost occurring in a case in which a slice is selected for each of the slices of the plurality of stages taken into account. In a case in which such a configuration is employed, slices of which costs are inhibited while satisfying the service requirement can be set, and accordingly, more appropriate slices can be set. In addition, in a case in which a configuration in which a combination of slices satisfying the service requirement and having a lowest cost is determined by the slice setting policy determining unit 13 as a combination of slices forming a slice setting policy is employed, slices capable of minimizing the cost can be set.

In addition, as described in the embodiment described above, when slices satisfy the service requirement and have a cost lower in a case in which a service is assigned to an existing slice in any one of plurality of stages than in a case in which a slice is newly generated, the slice setting policy determining unit 13 can determine to use the existing slice.

In a case in which such a configuration is employed, the NW operating device 10 can use an existing slice in a case in which assignment of the service to the existing slice is appropriate from viewpoints of the service requirement and the cost, and accordingly, resources can be more effectively utilized than in a case in which a slice is newly generated. In addition, an existing slice may be configured to be used only under a condition that the cost in a case in which a service is assigned to the slice becomes a minimum.

In addition, when slices satisfy the service requirement and have a cost lower in a case in which a service is assigned by extending resources of an existing slice in any one of a plurality of stages than in a case in which a slice is newly generated, the slice setting policy determining unit 13 can determine to use an existing slice by extending resources of the existing slice.

By employing such a configuration, in a case in which assignment of a service after extending an existing slice is appropriate from viewpoints of the service requirement and the cost, the NW operating device 10 can use resources of an existing slice by extending the resources of the existing slice, and accordingly, the resources can be more effectively utilized than a case in which a slice is newly generated. In addition, resources of an existing slice may be configured to be used by extending resources of the existing resource only under a condition that the cost in a case in which a service is assigned becomes a minimum.

In addition, in the embodiment described above, a case in which a service requirement is transmitted from the service operating device 40 when a new service is introduced has been described. However, the setting of slices described in the embodiment described above may be applied when the service requirement is changed from an existing service other than the introduction of a new service. In such a case, a service requirement after change is transmitted from a device corresponding to the service operating device 40. The NW operating device 10 performs a process similar to that according to the embodiment described above on the basis of the received service requirement, and accordingly, slices for a service after change can be appropriately set.

In addition, in the embodiment described above, although an example in which an RAN slice and a CN slice are arranged has been described as an example in which slices are arranged in a plurality of stages in a communication path, the number of slices (the number of stages of slices arranged on the communication path) may be three or more, and a slice other than the RAN slice and the CN slice may be arranged. Examples of the slice other than the RAN slice and the CN slice are a slice arranged in a transport region between the RAN and the CN, a slice arranged in an Internet region, a slice in the UE, and the like. A slice arranged in the transport region, for example, can be arranged by controlling a communication route between the RAN and the CN and securement of a certain frequency band, and the like using the SDN-C. In this way, a slice other than the RAN slice and the CN slice may be configured to be arranged on a communication path when the UE receives a service. Also in such a case, by performing cost calculation using the NW operating device 10, slices, of which costs are appropriately inhibited, arranged on a communication path can be set.

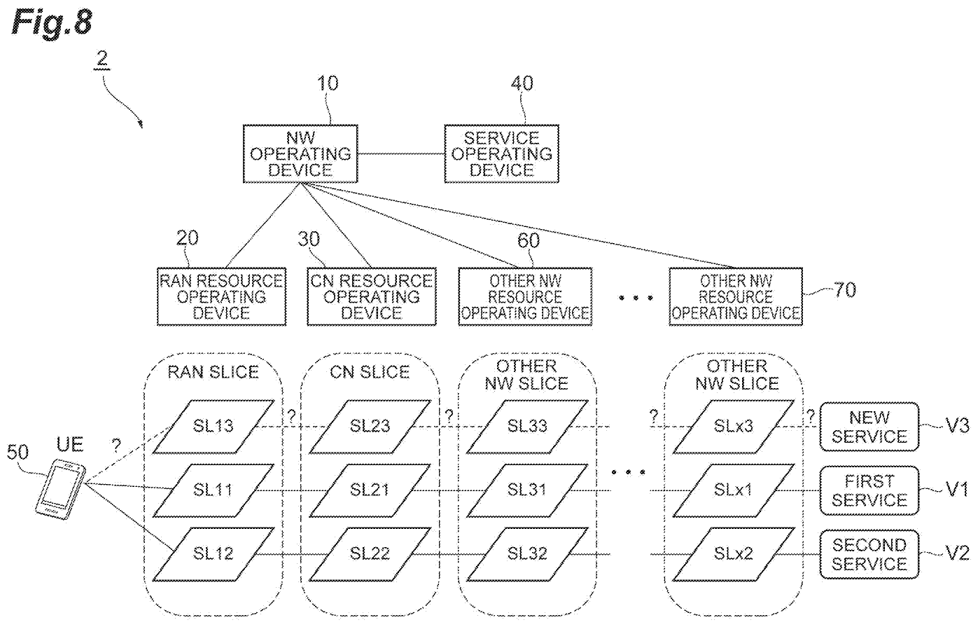

FIG. 8 illustrates an example of a communication system in which the number of stages of slices arranged on a communication path is three or more. In the communication system 2 illustrated in FIG. 8, an example in which “other NW slices” are arranged in a multiple stages at a later stage of a CN slice is illustrated. As one example, FIG. 8 illustrates other NW slices SL31 to 33 operated by another NW resource operating device 60 and other NW slices SLx1 to x3 operated by another NW resource operating device 70. An example in which, in a case in which a UE 50 uses a first service, the UE 50, after also accessing the slice SL31 and the slice SLxl, communicates with a service server V1 of the first service is illustrated. In addition, an example in which, in a case in which a UE 50 uses a second service, the UE 50, after also accessing the slice SL32 and the slice SLx2, communicates with a service server V2 of the second service is illustrated. Additionally, in each stage, whether the slice SL33 or the slice SLx3 is newly arranged in correspondence with a new service or the new service overlaps with existing slices is determined on the basis of cost calculation. In addition, although two other NW resource operating devices are illustrated in the communication system 2, the number of other resource operating devices in the communication system 2 may be appropriately changed.

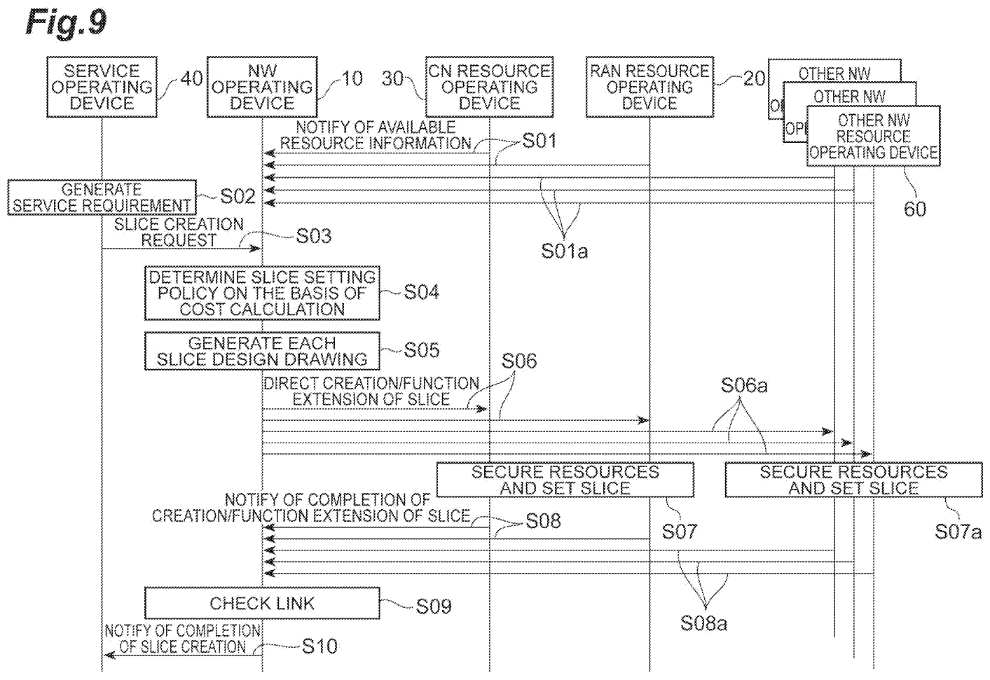

A more specific sequence is illustrated in FIG. 9. FIG. 9 is a diagram corresponding to FIG. 7 that is a sequence diagram illustrating a sequence, in a case in which a new service is introduced, relating to the communication system 1. Similar to the communication system 2, in a case in which the number of stages of slices arranged on a communication path is larger than that of the communication system 1, the process performed in the caser of introducing a new service is similar to that of the communication system 1. More specifically, the RAN resource operating device 20 and the CN resource operating device 30 notify the NW operating device 10 of available resource information (S01). At this time, another NW resource operating device 60 (although only another NW resource operating device 60 is illustrated in FIG. 9 as an example, another NW resource operating device operating slices of stages performs a similar process in the case of multiple stages) also notifies the NW operating device 10 of available resource information (S01a). Such information, similar to the communication system 1, is stored in the slice information storing unit 12 of the NW operating device 10.

Next, a service requirement generated by the service operating device 40 (S02) is transmitted from the service operating device 40 to the NW operating device 10 (S03), and the information is transmitted from the information acquiring unit 11 to the slice setting policy determining unit 13 in the NW operating device 10. Then, the slice setting policy determining unit 13 of the NW operating device 10 performs cost calculation on the basis of the service requirement transmitted from the service operating device 40 and the information stored in the slice information storing unit 12 and determines a slice setting policy (S04). When a slice setting policy is determined by the slice setting policy determining unit 13 of the NW operating device 10, after calculation with a cost of a slice set by another NW resource operating device also taken into account is performed, a slice setting policy capable of further inhibiting the cost is determined. When the slice setting policy is determined, the slice setting policy determining unit 13 generates each slice design drawing for setting slices in the RAN resource operating device 20, the CN resource operating device 30, and other NW resource operating device (S05). Thereafter, the slice design drawing is transmitted from the slice setting unit 14 of the NW operating device 10 to the RAN resource operating device 20 and the CN resource operating device 30, and the setting of slices represented in the slice design drawing is directed (S06). In addition, the slice design drawing is also transmitted from the slice setting unit 14 of the NW operating device 10 to another NW resource operating device, and the setting of slices represented in the slice design drawing is directed (S06a).

The RAN resource operating device 20 and the CN resource operating device 30 perform securing of physical resources required for slices and setting of the slices on the basis of the slice setting policy transmitted from the NW operating device 10 and set the slices represented in the slice design drawing (S07). At this time, another NW resource operating device also performs securing of physical resources required for slices and setting of the slices on the basis of the slice setting policy transmitted from the NW operating device 10 and sets the slices represented in the slice design drawing (S07a). When the setting of the slices is completed, completion of the process is notified from each of the RAN resource operating device 20 and the CN resource operating device 30 to the NW operating device 10 (S08). Similarly, also from another NW resource operating device to the NW operating device 10, completion of the process is notified (S08a).

When notifications indicating completion of the processes relating to setting of the slices are received from the RAN resource operating device 20 and the CN resource operating device 30, the slice setting unit 14 of the NW operating device 10 checks that a communication path from the UE to the service server through the set slices is secured (linked) and the service requirement is satisfied (S09). In a case in which it is checked by the slice setting unit 14 that a communication path from the UE to the service server through the set slices is secured and the service requirement is satisfied, completion of the process relating to the setting of slices is notified from the slice setting unit 14 to the service operating device 40 (S10). As described above, the process relating to setting of slices corresponding to a new service is completed in the communication system 2.

In this way, also in a case in which the number of stages of slices arranged on a communication path is three or more, cost calculation based on the number of stages is performed by the NW operating device 10, and accordingly, slices, of which a cost is inhibited appropriately, arranged on the communication path can be set.

In addition, although a case in which the RAN slice is arranged in a radio access network has been described in the embodiment described above, slices may be arranged also in a wire access network. In other words, when a user terminal uses a service, communication through a slice arranged in a wire access network and a slice arranged in a core network may be configured to be performed. Also in such a case, the NW operating device 10 performs cost calculation, whereby slices corresponding to the service can be appropriately set.

Each block diagram used for description of the embodiment described above illustrates blocks in units of functions. Such functional blocks (component units) are realized by an arbitrary combination of hardware and/or software. In addition, a means for realizing each functional block is not particularly limited. In other words, each functional block may be realized by one device that is combined physically and/or logically or a plurality of devices by directly and/or indirectly (for example, using a wire and/or wirelessly) connecting two or more devices separated physically and/or logically.

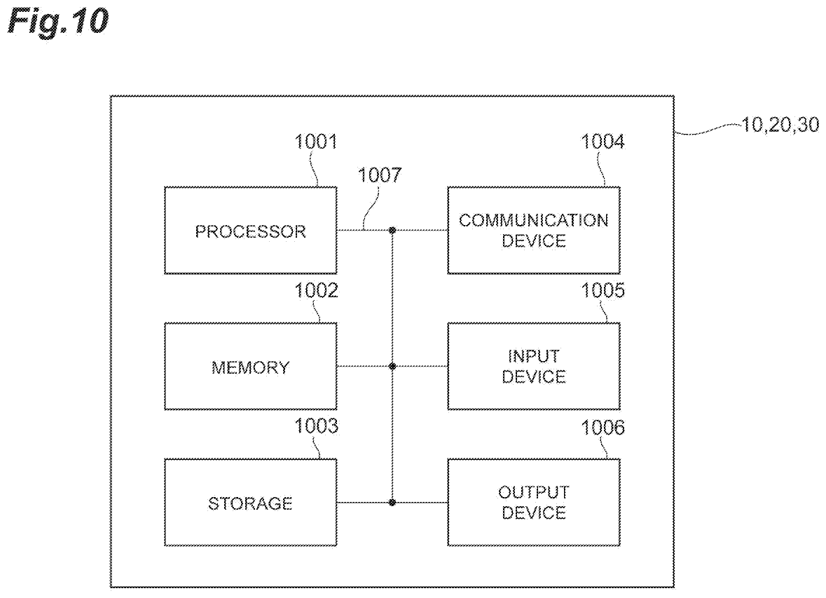

For example, the NW operating device 10, the RAN resource operating device 20, the CN resource operating device 30, other NW resource operating devices, and the like according to one embodiment of the present invention may function of a computer that performs the processes according to this embodiment. FIG. 10 illustrates one example of the hardware configuration of the NW operating device 10, the RAN resource operating device 20, and the CN resource operating device 30 according to this embodiment. Each of the NW operating device 10, the RAN resource operating device 20, and the CN resource operating device 30 described above, physically, may be configured as a computer device including a processor 1001, a memory 1002, a storage 1003, a communication device 1004, an input device 1005, an output device 1006, a bus 1007, and the like.

In addition, in the following description, a term “device” may be rephrased with a circuit, a device, a unit, or the like. The hardware configuration of the NW operating device 10, the RAN resource operating device 20, and the CN resource operating device 30 may be configured to include one or a plurality of devices illustrated in the drawing and may be configured without including some devices.

Each function of the NW operating device 10, the RAN resource operating device 20, and the CN resource operating device 30 is realized by the processor 1001 performing an arithmetic operation by causing predetermined software (a program) to be read onto hardware such as the processor 1001, the memory 1002, and the like and controlling communication using the communication device 1004 and data reading and/or data writing using the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like. For example, the slice setting policy determining unit 13 of the NW operating device 10 and the like may be realized by the processor 1001.

In addition, the processor 1001 reads a program (a program code), a software module, and data from the storage 1003 and/or the communication device 1004 into the memory 1002 and executes various processes in accordance with these. As the program, a program causing a computer to execute at least some of the operations described in the embodiment described above is used. For example, the information acquiring unit 11 of the NW operating device 10 may be realized by a control program that is stored in the memory 1002 and is operated by the processor 1001, and the other functional blocks may be similarly realized. Although the various processes described above have been described to be executed by one processor 1001, the processes may be executed simultaneously or sequentially by two or more processors 1001. The processor 1001 may be mounted using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable for performing the radio communication method according to one embodiment of the present invention.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blue-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including the memory 1002 and/or a storage 1003, a server, or any other appropriate medium.

The communication device 1004 is hardware (a transmission/reception device) for performing inter-computer communication through a wired and/or wireless network and, for example, may also be called as a network device, a network controller, a network card, a communication module, or the like. For example, the information acquiring unit 11, the slice setting unit 14, and the like of the NW operating device 10 described above may be realized by the communication device 1004.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the NW operating device 10, the RAN resource operating device 20, and the CN resource operating device 30 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

As above, while this embodiment has been described in detail, it is apparent to a person skilled in the art that this embodiment is not limited to the embodiments described in this specification. This embodiment may be modified or changed without departing from the concept and the scope of the present invention set in accordance with the claims. Thus, the description presented in this specification is for the purpose of exemplary description and does not have any limited meaning for this embodiment.

Notification of information is not limited to an aspect/embodiment described in this specification and may be performed using a different method. For example, the notification of information may be performed using physical layer signaling (for example, downlink control information (DCI), uplink control information (UCI), upper layer signaling (for example, radio resource control (RRC) signaling, medium access control (MAC) signaling, notification information (a master information block (MB), and a system information block (SIB)), any other signal, or a combination thereof. In addition, the RRC signaling may be referred to as a RRC message and, for example, may be an RRC connection setup message, an RRC connection reconfiguration message, or the like.

Each aspect/embodiment described in this specification may be applied to long term evolution (LTE), LTE-advanced (LTE-A), Super 3G, IMT-advanced, 4G, future ratio access (FRA), W-CDMA™, GSM™, CDMA 2000, ultra-mobile broadband (UMB), IEEE 802.11 (Wi-Fi), IEEE 802.16 (WiMAX), IEEE 802.20, ultra-wideband (UWB), Bluetooth™, a system using another appropriate system and/or a next generation system extended based on these.

The processing sequence, the sequence, the flowchart, and the like of each aspect/embodiment described in this specification may be changed in order as long as there is no contradiction. For example, in a method described in this specification, elements of various steps are presented in an exemplary order, and the steps are not limited to be in the presented specific order.

In this specification, a specific operation performed by a specific device may be performed by an upper node thereof depending on the situation.

Information and the like can be output from an upper layer (or a lower layer) to a lower layer (or an upper layer). The information and the like may be input and output through a plurality of network nodes.

The input/output information and the like may be stored in a specific place (for example, a memory) or managed using a management table. The input/output information and the like can be overwritten, updated, or additionally written. The output information and the like may be deleted. The input/output information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in this specification may be use individually or in combination or may be used by being switched therebetween in accordance with execution. In addition, a notification of predetermined information (for example, a notification of being X) is not limited to be performed explicitly and may be performed implicitly (for example, a notification of the predetermined information is not performed).

It is apparent that software, regardless whether it is called software, firmware, middleware, a microcode, a hardware description language, or any other name, should be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, and the like may be transmitted and received via a transmission medium. For example, in a case in which software is transmitted from a website, a server, or any other remote source using wiring technologies such as a coaxial cable, an optical fiber cable, a twisted pair, a digital subscriber line (DSL) and the like and/or radio technologies such infrared rays, radio waves, and microwaves, and the like, such wiring technologies and/or radio technologies are included in the definition of the transmission medium.

Information, a signal, and the like described in this specification may be represented using any one among other various technologies. For example, data, an instruction, a command, information, a signal, a bit, a symbol, a chip, and the like described over the entire description presented above may be represented using a voltage, a current, radio waves, a magnetic field or magnetic particles, an optical field or photons, or an arbitrary combination thereof.

In addition, terms described in this specification and/or terms that are necessary for understanding this specification may be substituted with teal's having the same meaning or a meaning similar thereto. For example, a channel and/or symbol may be a signal. In addition, a signal may be a message. Furthermore, a component carrier (CC) may also be referred to as a carrier frequency, a cell, or the like.

Terms “system” and “network” used in this specification are compatibly used.

In addition, information, a parameter, and the like described in this specification may be represented using absolute values, relative values from predetermined values, or other corresponding information. For example, radio resources may be directed using indices.

A name used for each parameter described above is not limited in any aspect. In addition, numerical equations using such parameters may be different from those that are explicitly disclosed in this specification. Various channels (for example, a PUCCH, a PDCCH, and the like) and information elements (for example, a TPC and the like) can be identified using all the preferred names, and various names assigned to such various channels and information elements are not limited in any aspect.

A user terminal may be called as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a hand set, a user agent, a mobile client, a client, or any other appropriate terms by persons skilled in the art.

Terms such as “determining” used in this specification may include operations of various types. The “determining,” for example, can include a case in which judging, calculating, computing, processing, deriving, investigating, looking up (for example, looking up in a table, a database, or any other data structure), and ascertaining are regarded as “determining.” In addition, “determining” may include a case in which receiving (for example, receiving information), transmitting (for example, transmitting information), input, output, or accessing (for example, accessing data in a memory) is regarded as “determining ” Furthermore, “determining” may include a case in which resolving, selecting, choosing, establishing, comparing, or the like is regarded as “determining.” In other words, “determining” may include a case in which a certain operation is regarded as “determining.”

Terms such as “connected” or “coupled” or all the modifications thereof mean all the kinds of direct or indirect connection or coupling between two or more elements and may include presence of one or more intermediate elements between two elements that are mutually “connected” or “coupled.” Coupling or connection between elements may be physical coupling or connection, logical coupling or connection, or a combination thereof. When used in this specification, two elements may be considered as being mutually “connected” or “coupled” by using one or more wires, cables and/or print electric connections and, as several non-limiting and non-comprehensive examples, by using electromagnetic energy such as electromagnetic energy having wavelengths in a radio frequency region, a microwave region, and a light (both visible light and non-visible light) region.

A reference signal may be abbreviated to a reference signal (RS) and may be referred to as a pilot according to applicable standards.

Description of “on the basis of” used in this specification does not mean “on the basis of only” unless otherwise mentioned. In other words, description of “on the basis of” means both “on the basis of only” and “on the basis of at least.”

In this specification, in a case in which names such as “first,” “second,” and the like is used, reference to all the elements does not generally limit the amount or the order of such elements. Such names may be used in this specification as a convenient way for distinguishing two or more elements from each other. Accordingly, reference to the first and second elements means none of that only the two elements are employed therein nor that the first element precedes the second element in a certain way.

As long as “include,” “including,” and modifications thereof are used in this specification or the claims, such terms are intended to be inclusive like a term “comprising.” In addition, a term “or” used in this specification or the claims is intended to be not an exclusive logical sum.

Other than a case in which there is obviously only one device in a context or technically, a plurality of devices may be included.

In the entirety of the present disclosure, unless a singularity is represented clearly from the context, it includes plurality ones.

### REFERENCE SIGNS LIST

1 Communication system

10 NW operating device

11 Information acquiring unit

12 Slice information storing unit

13 Slice setting policy determining unit

14 Slice setting unit

20 RAN resource operating device

30 CN resource operating device

1. A slice management device assigning a service using a virtual network to slices that are virtual networks generated on a network infrastructure,
the slices being arranged in a plurality of stages of a communication path along which communication is performed between a user terminal using the service and a service server providing the service,
the slice management device comprising:
an information acquiring unit that acquires a slice setting request including a service requirement that is a requirement of a function or performance in a service provided using the virtual network;
a slice setting policy determining unit that determines a setting policy for setting slices which satisfy the service requirement as the slices of the plurality of stages on the basis of results of comparison of costs calculated in accordance with settings of the slices of the plurality of stages; and
a slice setting unit that performs a process relating to the settings of the slices in the plurality of stages on the basis of the setting policy determined by the slice setting policy determining unit.

2. The slice management device according to claim 1, wherein, in a case in which the service requirement is satisfied, and the cost is lower in a case in which the service is assigned to an existing slice in any one of the plurality of stages than in a case in which a slice is newly generated, the slice setting policy determining unit uses the existing slice.

3. The slice management device according to claim 1, wherein, in a case in which the service requirement is satisfied, and the cost is lower in a case in which the service is assigned to an existing slice by extending resources of the existing slice in any one of the plurality of stages than in a case in which a slice is newly generated, the slice setting policy determining unit uses the existing slice by extending the resources of the existing slice.

4. A slice management method using a slice management device assigning a service using a virtual network to slices that are virtual networks generated on a network infrastructure,
the slices being arranged in a plurality of stages of a communication path along which communication is performed between a user terminal using the service and a service server providing the service,
the slice management method comprising:
an information acquiring step of acquiring a slice setting request including a service requirement that is a requirement of a function or performance in a service provided using the virtual network;
a slice setting policy determining step of determining a setting policy for setting slices which satisfy the service requirement as the slices of the plurality of stages on the basis of results of comparison of costs calculated in accordance with settings of the slices of the plurality of stages; and
a slice setting step of performing a process relating to the settings of the slices of the plurality of stages on the basis of the setting policy determined in the slice setting policy determining step.
